(19) United States
(12) Patent Application Publication
(10) Pub. No.: US 2006/0230051 A1
(43) Pub. Date: Oct. 12, 2006

(54) Method to share and exchange geographic based information

(75) Inventor: John Corbett, Denver, CO (US)

Correspondence Address: John Dodds, 1707 N St. NW, Washington, DC, 20036, US

(73) Assignee: Muds Springs Geographers Inc.

(21) Appl. No.: 11/102,294

(22) Filed: Apr. 8, 2005

(51) Int. Cl. G06F 7/00

(52) U.S. Cl. 707/101

(57) ABSTRACT

A simplified approach to sharing and exchanging geographic-based information containing the maps and corresponding data and metadata was developed to enable easy sharing of information for decision support tools. Current Geographical Information Systems (GIS) technologies are limited in their ability to share maps and data in the exact format that the user created the information. This technology shares the corresponding data with the map information (not just a ‘picture’ of the data—e.g., a static map) in the exact form that the user wants to provide to other users of the software application. The technology and use of this software application provides the unique ability for users to share the information directly with other users of the software, eliminating process and setup of importing new information into the spatial decision-support software. Users can then utilize the information to explore the map and database information, to add their own data, and to make further decisions, enabling them to modify and change the information and exchange the information with others in the same manner.

### BACKGROUND OF THE INVENTION

Managing, organizing and displaying geographic information using computers has become increasingly common. Such use of geographic information has proved to be valuable in many industries and organizations, such as governmental agencies, public utilities, and agribusiness. Computer display of geographic information allows vast amounts of information to be efficiently communicated to users and allows the geographic information to be easily edited.

With the recent explosive growth of the Internet, numerous geographic information resources at remote sites around the world have become instantly available to users, regardless of their location. Along with the increasing availability of location based information, there has been a corresponding increase in the difficulty and complexity of referencing, organizing, and managing geographic resources. In order to retrieve geographic information, the user or the retrieving computer must acquire the information and process it into its own set of rules and procedures. There are no universally accepted display formats for geographic data types—they may be configured according to any of a large number of display formats. In order to retrieve and display geographic information, geographic information systems (GIS) must have data and metadata relating to the geographic information and specifying the information that is provided within.

Some basic GIS applications require the user to remember the description of relevant geographic information and to manually type in the information from memory or hard copy in order to retrieve and display the information. Several major geographic information system vendors have recently marketed open GIS applications, which include open platforms and which are compatible with a large number of display formats. While such open standards increase the amount of geographic information that is accessible to a user using a single application, they do nothing to facilitate the organization and interrelation of various geographic information sources and geographic data structures. None of the existing systems do enable the user to store multiple views of same data (zoom and color rendering), to freely exchange and amend existing data and to display the data with the same exactness as in the original database.

Many of the problems that are impeding the full potential and applicability of geographic information systems have not been adequately addressed by conventional approaches. There still exists the difficulty of exchanging freely available geographic information to all interested users within an organization. Moreover, there is no geographic information system that can adequately coordinate the use and execution of multiple applications that may be needed to display geographic information originating from different data sources.

In view of the foregoing, there is a need in the art for systems and methods of organizing geographic information located at remote sources in such a way that it is easily accessible and displayable to users. It would be a further advantage if such methods could conveniently facilitate the exchange and distribution of geographic information to multiple users wherever they may be. The method according to the present disclosure provides remarkable improvements to the existing art by enabling easy and convenient exchange and/or sharing of GIS information with others.

### SUMMARY

The present invention is directed at simplifying and making GIS information easy to share with others, with the objects maintaining the exactness and reproducibility of the information from one GIS to the other, without any further processing. The exchange technology according to this invention enables GIS information fully populated by data and metadata to be exchanged as a single exchange file. Processing and further analysis are not limited once the exchange file is imported into a new or existing GIS database.

The reference information compiled by one user is immediately stored and can be shared with others having the same tool to open the exchange file. The users may relate to various properties and features of the geographic data structures. For example, the exchange file may have information on climate that includes the reference to weather stations allowing a user application executed by the user's computer to retrieve the geographic data structure from a remote source on the Internet or another wide area network. The reference information may also include display information defining the display format to be used by the user application to display the geographic data structure to the user.

The exchange file contains application information indicating how the application should display the geographic data structure. The exchange file associated with the application may be stored locally by the computer executing the user application, or instead may be transferred and then stored at a remote site on the Internet or another wide area network, thereby making it available to any other user. Metadata, which is data describing when the geographic data was created, by whom it was created, how it can be used, or other information about the geographic data, may be included in the reference information.

Users of the technology according to this disclosure can exchange complex location-specific information via exchange-function. The user is presented selection mechanisms to extract data from the exchange file (the default is all the information in the exchange file). When the user selects the geographic information to be retrieved, the user application receives the reference information associated with the relevant geographic data structures, brings the geographic data into the database, displays it as the exchange file creator designed, and completes the insertion of the meta-data into the database. In addition to geographic information, the systems and methods of the invention can be used to organize, manage, retrieve, and display tabular data and other data, such as geo-located documents, graphics (including photographs), audio and video.

Compiling the reference information and establishing the relationships between referenced geographic data structures in the foregoing manner provide significant advantages not available using prior art systems and methods. The selection of tabular data sources, or databases, can be based on the nature of the data in the database and its usefulness for presenting on a map the significance or attributes of one or more specific geographic features. For example, the data contained in the database can be used to draw a map in a specified way, or it can be displayed in a table as pertaining to particular map features.

In addition, the geographic data, tabular data, and applications are typically selected by originator based on the relationships between data. For example, to depict a map to a user, applications need the geographic data and tabular data to be available at the user's computer. Thus, the originator can compile the reference information in such a way that, when a user executes an application, the appropriate tabular data and geographic data can be automatically accessed by the application. In this way, the user is relieved of the task of finding and/or entering the necessary geographic and tabular data as has been practiced in the prior art.

Additional objects and advantages of the invention will be set forth in the description that follows. The objects and advantages of the invention may be realized and obtained by means of the instruments and combinations particularly pointed out in the appended claims. These and other objects and features of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic diagram illustrating a system according to the disclosure for referencing and retrieving geographic, tabular, and other data structures stored in database files

FIG. 2 Shows digitally rendered map composed of many layers of data in A Where interface.

FIG. 3a, b, c show illustrates import/export functions on one preferred embodiment.

FIG. 4a, b, show examples of displaying geographic information to a user after the exchange file has been imported.

### DETAILED DESCRIPTION OF THE INVENTION

A simplified approach to sharing and exchanging geographic-based information containing the maps and corresponding data and metadata was developed to enable easy sharing of information for decision support tools. Current Geographical Information Systems (GIS) technologies are limited in their ability to share maps and data in the exact format that the user created the information. This technology shares the corresponding data with the map information (not just a ‘picture’ of the data—e.g., a static map) in the exact form that the user wants to provide to other users of the software application. The technology described in this disclosure provides the unique ability for users to share the information directly with other users of the technology, eliminating process and setup of importing new information into the decision-support software. Users can then utilize the information to explore the map and database information, to add their own data, and to make further decisions, enabling them to modify and change the information and exchange the information with others in the same manner.

The present invention is directed at simplifying and making GIS information easy to share with others while maintaining the exactness and reproducibility of the information from one GIS to the other, without any further processing. Sharing and exchanging the information is enabled by sharing/exchanging an exchange file that contains necessary information for creating an exact copy of a map, data, attachment, color rendering and metadata into a new or existing map database. Processing is not limited once the exchange file is imported into a new or an existing GIS database.

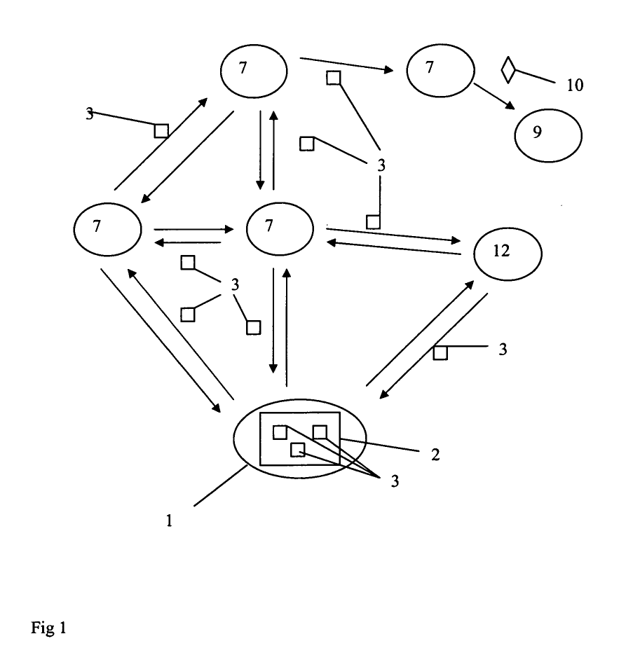

Now specifically referring to FIG. 1 the Exchange file 3 created by an originator 12 is deposited in an exchange file depository 2 locating in the internet 1. Alternatively, the exchange file 3 can be saved by any digital means and delivered to the users 7. A user 7 can receive an exchange file 3 from the depository 2 or directly from the originator 12 or another user 7. An exchange file 3, once created, contains all necessary information to do further analysis on the geographic data (data are transferred), to display as the originator intended (the color rendering is included in the exchange file), and to reference correctly (each data-layer and each attribute's description, including formal reference information as appropriate, transfer within exchange to another user). The transfer of an exchange file 3 from the originator 12 to any user 7 delivers a set of information just described. The user 7 is now enabled to add, modify, change or create new location based information in his database (e.g., he may join a private spread-sheet or database data to the existing location-based data). The user can save the Exchange file 3 on his computer and share his modification for example as a pdf. file, PowerPoint file or a print out 10 with a decision maker 9 or any other person or organization. This user 7 could then create a new exchange file to be sent to any user 7 including the originator 12 of the first exchange file.

The reference information compiled by one user 7 is immediately stored and can be shared with others having the same tools to open the exchange file 3. The users 7 may relate to various properties and features of the geographic data structures. For example, the exchange file 3 may have information on climate that includes the reference to weather stations allowing a user application executed by the user's computer to retrieve the geographic data structure from a remote source on the Internet or another wide area network. The reference information may also include display information defining the display format to be used by the user application to display the geographic data structure to the user 7.

The exchange file 3 contains application information indicating how the application should display the geographic data structure. The exchange file 3 associated with the application may be stored locally by the computer executing the user application, or instead may be stored at an exchange file deposit 2 at a remote site on the Internet or another wide area network 1. Metadata, which is data describing when the geographic data structure was created, by whom it was created, how it can be used, or other information about the geographic data structure, may be included in the reference information.

By compiling the reference information and establishing the relationships between referenced geographic data structures, the originator has organized the data so that they can be conveniently retrieved and displayed by the user application.

In particular, the user application presents menu choices, lists, or other selection mechanisms to the user 7 indicating what geographic information is available to the user 7. When the user 7 selects the geographic information to be retrieved, the user application receives the reference information associated with the relevant geographic data structures. The geographic data structures and any applications not already stored locally are retrieved from the remote sources. Using the display information, the user application displays the geographic information to the user 7. In addition to geographic information, the systems and methods of the invention can be used to organize, manage, retrieve, and display tabular data and other data, such as graphics, audio and video.

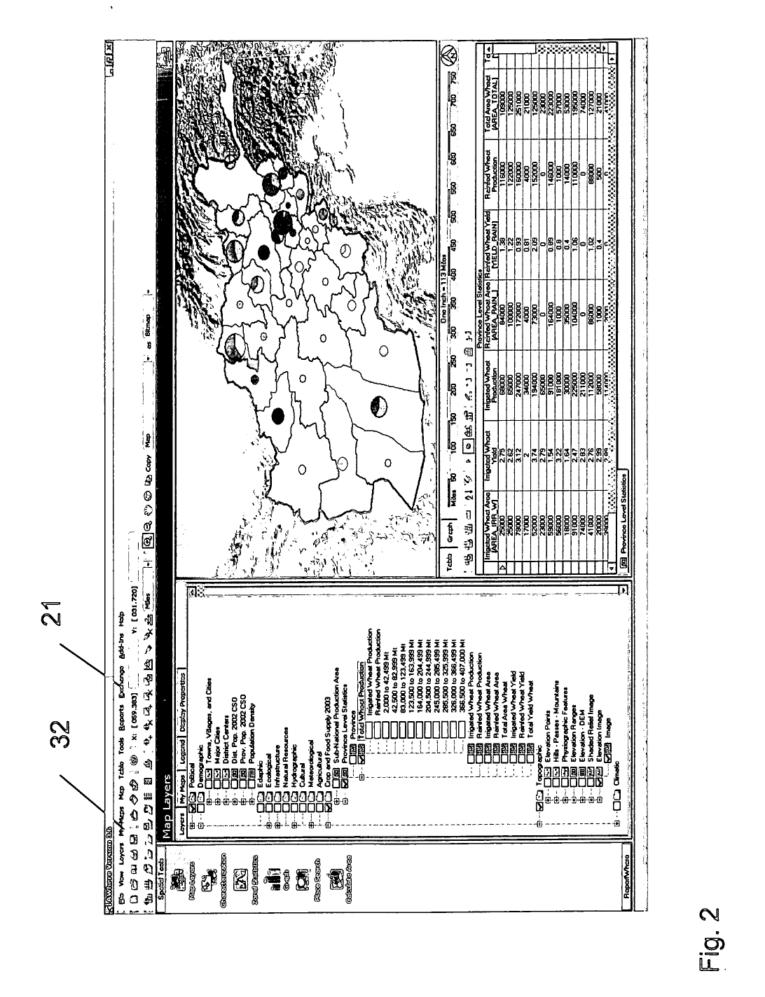

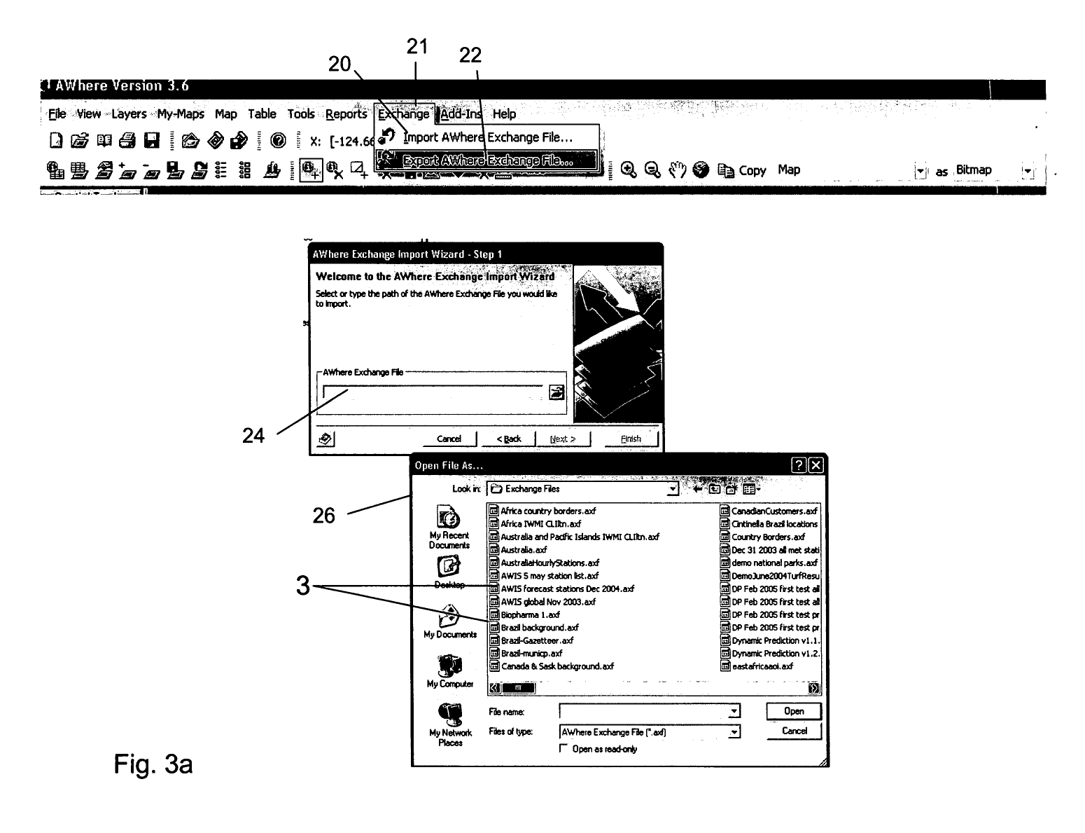

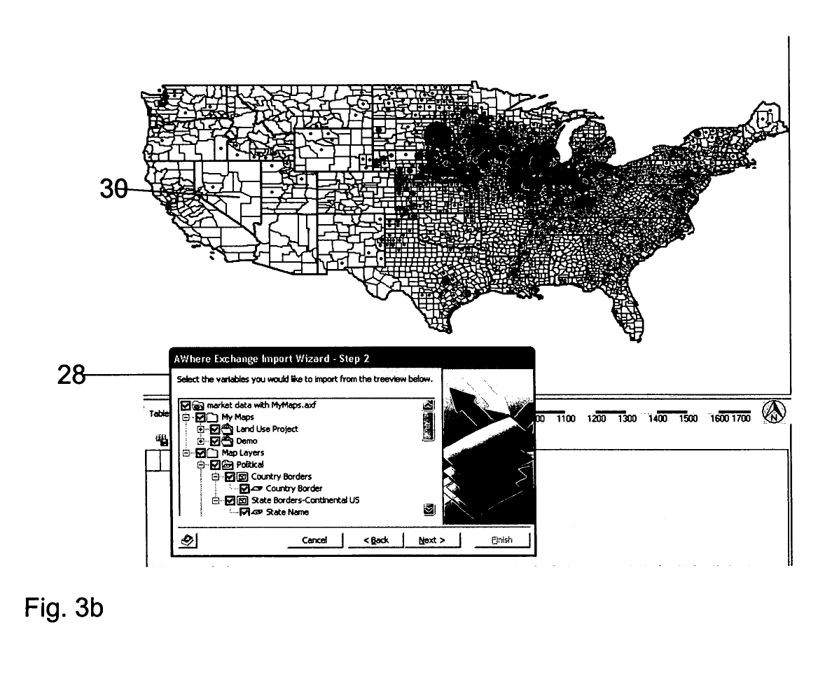

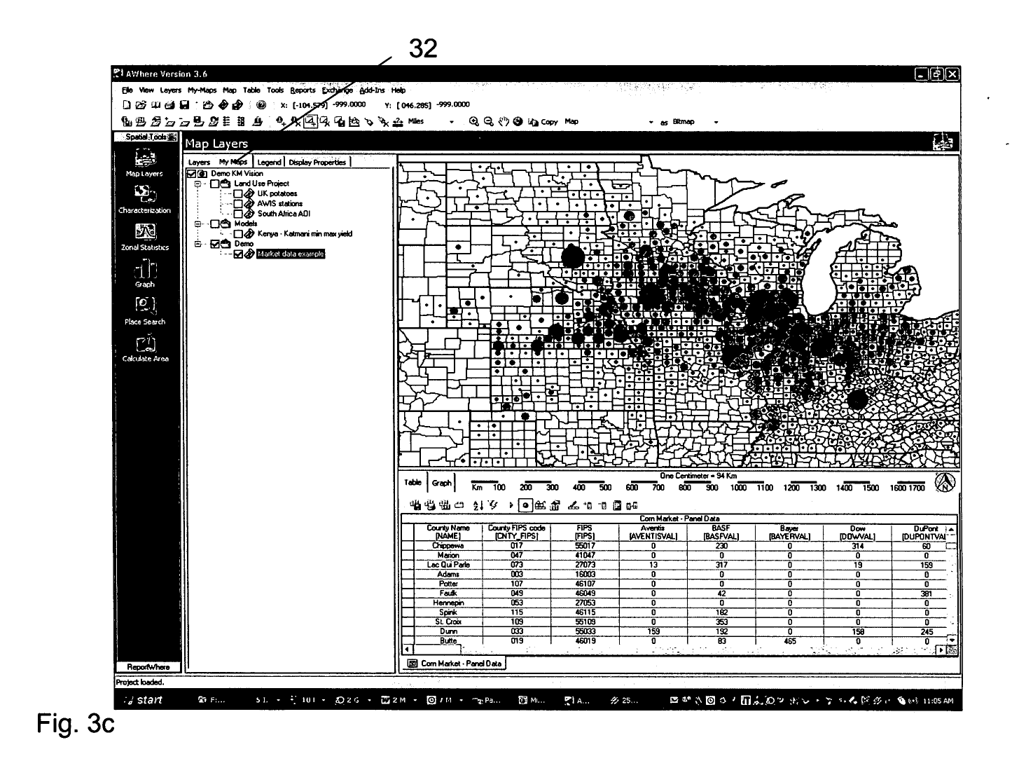

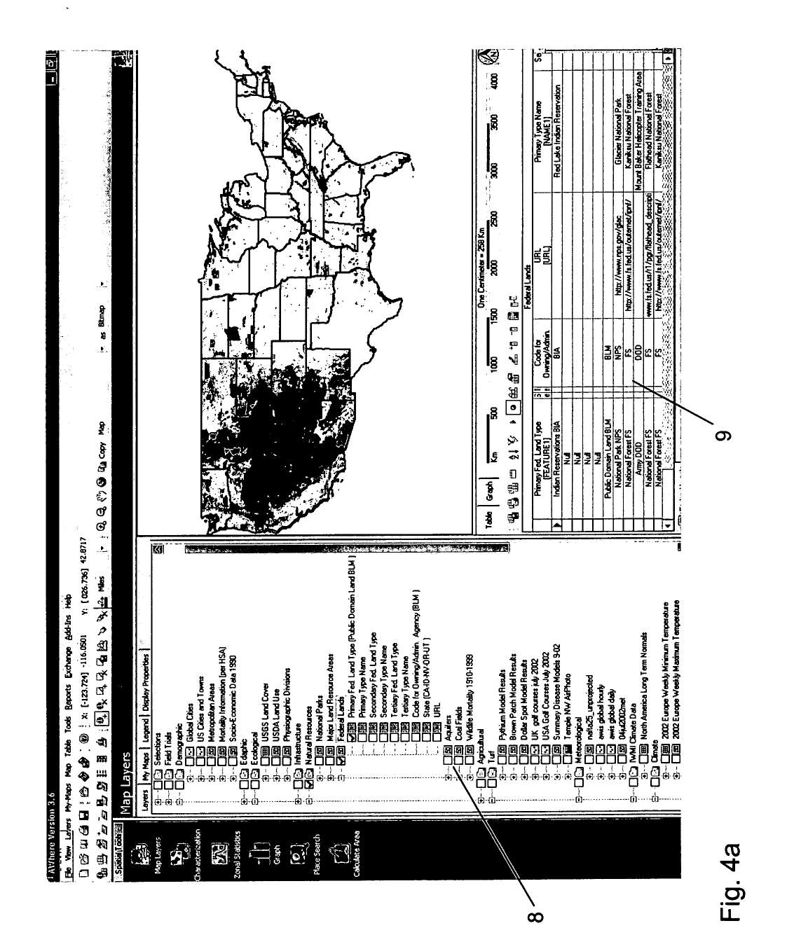

FIG. 2 shows a digitally rendered map composed of many layers of data in A Where Exchange interface, which is one preferred embodiment of the technology according to this disclosure. Each layer of data includes its own color rendering, metadata, labels, map charts (here pie charts) and geographic extent. A where Exchange stores all of the attributes from each layer, packages this information with each layer (the shapefile), then compresses all the information into a single exchange file that can be transferred via any digital means. Shapefiles are an open-source format originally authored by ESRI (Environmental Science Research Institute, Redlands Calif.). Exchange files can be made inter-operable with ESRI's software product ArcGIS via an interoperability extension. Without the ability to read an Exchange file, users of GIS software that can read/import shapefiles (shapefiles are an industry standard) can retrieve the shapefile part of the data in an exchange file but will be unable to take advantage of all the supplemental data (color rendering, view, metadata etc) contained in Exchange and would thus have to manually enter all these additional data. Upon import, the next user receives not only the data behind each map view but also the exact map view as prepared by the originator. By clicking MyMaps function 32 the exact zoom information embedded in exchange file can be viewed. A where Exchange can add data to a new, empty database or append the data to an existing database. The user, selecting the Exchange-option 21 can add these data to a new, empty database or append the data to an existing database. Via export option 22 (FIG. 3a) the originator can create and store multiple views of the same data layers (various geographic extents e.g., zoom to Idaho in one and zoom to Ohio in another) or provide many customized views of any set of layers in the originators database. MyMaps—feature 32 (FIG. 3c) stores the geographic extent and multiple-views. A where Exchange captures, processes and compacts into a simple computer file, called exchange file all the digital information comprising the map, any map views, database, any geo-located attachments, and metadata components useful in GIS system to display, render and view and interpret map data.

The geographic data, tabular data, and applications are typically selected by the originator based on the relationships between them. For example, to depict a map to a user, applications need the geographic data and tabular data to be available at the user's computer. Thus, the originator can compile the reference information in such a way that, when a user executes an application, the appropriate tabular data and geographic data can be automatically accessed by the application.

Now specifically referring to FIG. 3a: By selecting Exchange function 21 the user is further provided to select import 20 or export 22 function from his user application. By choosing ‘export’ 22 he will be an originator. If import 21 is selected the user is enabled to navigate in browser 24 to select among existing exchange files 3 shown now in window 26. The browser 4 allows the user to look for an exchange file 3 anywhere on his computer or local-are network.

Now specifically referring to FIG. 3b: Upon selection, the program opens the exchange file of interest and provides a look at the contents in a tree-view window 28. The user is then allowed to unselect any layers or maps not desired. Once the user is satisfied, the import routine will bring all selected data and present the user the same map look 30 created by the originator with the elements the user wishes to view.

If the originator selects export function 22 (FIG. 3a) he has chosen to create an exchange file 3. The originator shall first be enabled to navigate to the location on the computer system where the exchange file to be created is wished to be stored. Once the file is named and location selected on the originator's computer system, the exchange export routine 22 presents the user with a view showing all data layers in the originator's open database. This view by default has layers checked for export that make up the existing view. The originator is enabled to turn on or off any layer of map in the originator's database. Once satisfied with the data and views to be exported, an export routine 22 will cause the system to collect all layers selected from any location on the originators computer system, add all information from the databases on color, meta-data, MyMaps if selected, the geographic zoom, and compress all this information into a single exchange file ready for transfer and import via import routines.

Now specifically referring to FIG. 3c all the data layers are found under MyMaps tabulator 32. Using MyMaps, the originator can create and store multiple views of the same data layers (various geographic extents e.g., zoom to Idaho in one and zoom to Ohio in another) or provide many customized views of any set of layers in the originator's database.

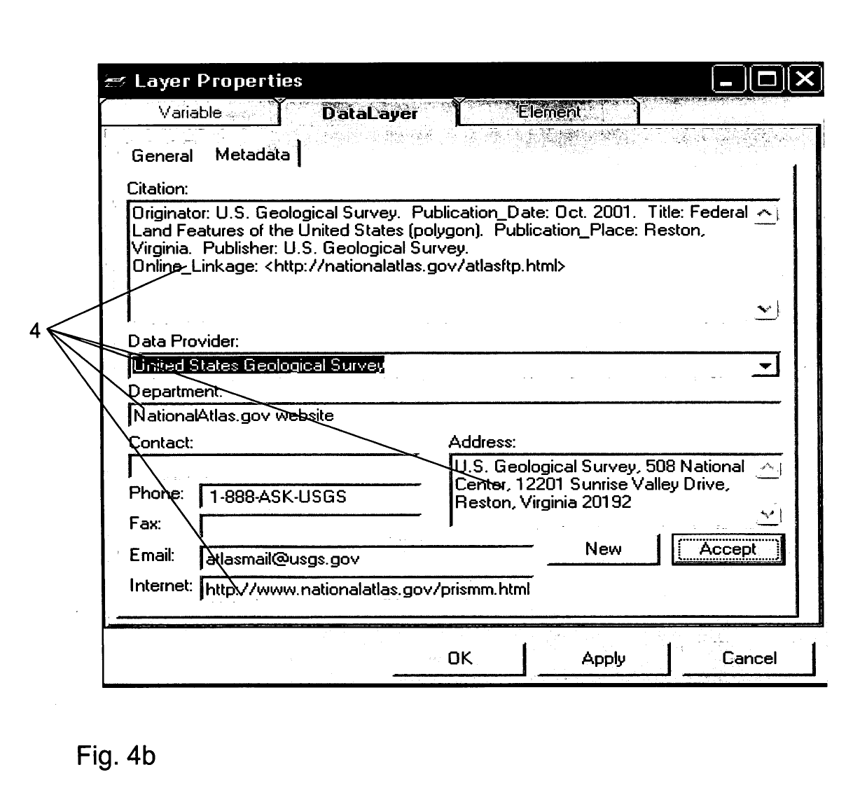

Now specifically referring to FIG. 4a: FIG. 4a shows a computer screen with originators fully populated database 8. The originator can select features he wishes to add to an exchange file. In the right side window the tabular data 9 and the map 10 to be saved in exchange file are shown.

FIG. 4b is a view of the window showing the metadata 4 embedded in the exchange file. The metadata includes information such as but not limited to the creator of the database, date of creation, reference address.

For one skilled in the art it is apparent that the present invention may be embodied in other specific forms without departing from its spirit or other essential characteristics. The described embodiments are to be considered in all respects only as illustrative and not restrictive. All changes that come within the range of equivalency of the claims are to be embraced within their scope.

What is claimed is:

1. A computer implemented method for retrieving and organizing geographic information available for display and analysis, said method enabling exchanging and sharing an exchange file with multiple users and said exchange file containing necessary information for creating an exact copy of the geographic information.

2. The method according to claim 1, wherein the exchange file is compressed and packaged as one unit for transfer to another user and the exchange file further comprises GIS-standard shapefiles, database records about the shapefiles, metadata about the layers rendering and displaying the shapefiles in an exact result, a geolocated attachment and metadata about creation of a map and its properties.

3. A method to share, exchange and organize location based information, said method comprising steps of:
a) an originator creating a single file comprising database information, map layers or other set of information based on geographic information;
b) the originator creating an exchange file, said exchange file further comprising:
i) reference to remote sources of geographic data structure,
ii)information indicating how geographic data structure is to be displayed, and
iii) metadata giving further information of the geographical data structure;
c) the originator sending the exchange file into an exhange file depository locating in internet server or other wide area network;
d) a user receiving an exchange file from exchange depository or directly from the originator;
e) the user deselecting layers of information that he does not need;
f) the user creating a new database consisting of layers of information that he needs; and
g) the user saving the new database.

4. A method according to claim 3, wherein the user can add information of selected layers to a database or map he already has saved on his computer.

5. An exchange file for sharing and exchanging geographic based information, said file comprising:
i) reference to remote sources of geographic data structure,
ii) information indicating how geographic data structure is to be displayed, and
iii) metadata giving further information of the geographical data structure; and
said exchange file further being capable to be transferred to various users and to be deposited in an exchange file depository locating in internet.
